(19) United States
(12) Patent Application Publication
(10) Pub. No.: US 2026/0242261 A1
(43) Pub. Date: Aug. 20, 2026

(54) UREA PROCESSING APPARATUS AND UREA PROCESSING METHOD

(71) Applicant: SAMSUNG ELECTRONICS CO., LTD., Suwon-si (KR)

(72) Inventors: Chang ha Lee, Seoul-si (KR); Soo Jin Shim, Suwon-si (KR); Ui min Kong, Seoul-si (KR); Seung Bae Oh, Suwon-si (KR); Je Hun Kim, Suwon-si (KR); Gyo hun Koo, Seoul-si (KR)

(73) Assignees: SAMSUNG ELECTRONICS CO., LTD., Suwon-si (KR); Seoul National University R&DB FOUNDATION, Seoul-si (KR)

(21) Appl. No.: 19/301,354

(22) Filed: Aug. 15, 2025

(30) Foreign Application Priority Data
Feb. 18, 2025 (KR) 10-2025-0020547

(51) Int. Cl. C02F 1/72; C02F 1/00; C02F 1/48; C02F 1/66; C02F 1/68; C02F 1/76; C02F 9/00; C02F 103/04; C02F 103/34

(52) U.S. Cl. CPC C02F 1/725; C02F 1/008; C02F 1/66; C02F 1/686; C02F 1/766; C02F 9/00; C02F 1/481; C02F 1/488; C02F 2103/04; C02F 2103/346; C02F 2209/06; C02F 2303/18

(57) ABSTRACT

An apparatus for processing urea in water to be processed is provided. The urea processing apparatus includes a water collection tank configured to provide water to be processed that contains a urea and a reaction tank configured to receive the water to be processed from the water collection tank and react the water to be processed with an oxidizer and a catalyst, wherein the reaction is performed at 10° C. to 40° C. for 60 minutes or less, and [Urea]/[Urea]0 is 0.1 or less (here, [Urea]0 means a molar concentration of urea in the water to be processed, and [Urea] means a molar concentration of urea after the reaction in the reaction tank.)

### CROSS-REFERENCE TO RELATED APPLICATION

This application claims priority from Korean Patent Application No. 10-2025-0020547 filed on Feb. 18, 2025 in the Korean Intellectual Property Office, and all the benefits accruing therefrom under 35 U.S.C. 119, the contents of which in their entirety are herein incorporated by reference.

### BACKGROUND

### 1. Field

The present disclosure relates to a urea processing apparatus and a urea processing method.

### 2. Description of Related Art

An ultrapure water production system used in the semiconductor manufacturing process may apply various physicochemical water processing technologies such as a reverse osmosis membrane, a UV process, an electric desalination, and an ion exchange. However, in the case of urea, due to its small molecular weight and uncharged characteristics, it may be difficult to remove more than 50% of the urea.

The urea which is not removed may remain in the water that is produced at a concentration exceeding a total organic carbon standard of the ultrapure water, which may act as a cause of wafer defects in the semiconductor manufacturing process.

From the viewpoint of scale-up and stable processing, a urea oxidation-degradation method using a free bromine oxidizer such as hypobromite (OBr⁻) has become one of the main technologies of the ultrapure water production systems.

### SUMMARY

Aspects of the present disclosure provide an apparatus for processing urea in the water to be processed.

Aspects of the present disclosure also provide a method for processing urea in water to be processed.

However, aspects of the present disclosure are not restricted to those set forth herein. The above and other aspects of the present disclosure will become more apparent to one of ordinary skill in the art to which the present disclosure pertains by referencing the detailed description of the present disclosure given below.

According to an aspect of the present disclosure, there is provided a urea processing apparatus comprising a water collection tank configured to provide water to be processed that contains urea and a reaction tank configured to receive the water to be processed from the water collection tank and react the water to be processed with an oxidizer and a catalyst, wherein the reaction is performed at 10° C. to 40° C. for 60 minutes or less, and [Urea]/[Urea]0 is 0.1 or less (here, [Urea]0 means a molar concentration of urea in the water to be processed, and [Urea] means a molar concentration of urea after the reaction in the reaction tank.)

According to another aspect of the present disclosure, there is provided a urea processing apparatus comprising a pH adjustment tank configured to control a hydrogen ion concentration (pH) of water to be processed and a reaction tank configured to receive the water to be processed from the pH adjustment tank and react the water to be processed with an oxidizer and a catalyst, wherein the reaction is performed at 10° C. to 40° C. for 60 minutes or less.

According to another aspect of the present disclosure, there is provided a urea processing apparatus comprising a water collection tank configured to provide water to be processed containing urea and a reaction tank configured to receive the water to be processed from the water collection tank and react the water to be processed with an oxidizer and a catalyst, wherein the oxidizer includes at least one of hypobromite (OBr⁻) or hypochlorite (ClO⁻), and the catalyst includes at least one of nickel oxide (NiO), nickel peroxide (Ni₂O₃) or nickel hydroxide (Ni(OH)₂).

It should be noted that the effects of the present disclosure are not limited to those described above, and other effects of the present disclosure will be apparent from the following description.

### BRIEF DESCRIPTION OF DRAWINGS

The above and other aspects and features of the present disclosure will become more apparent by describing in detail embodiments thereof with reference to the attached drawings, in which:

FIG. 1 is a diagram for explaining a urea processing apparatus according to some embodiments.

FIG. 2 is a diagram for explaining a urea processing apparatus according to some embodiments.

FIG. 3 is a diagram for explaining a urea processing apparatus according to some embodiments.

FIG. 4 is a sequence flow diagram for explaining the urea processing method according to some embodiments.

FIGS. 5 to 8 are graphs showing the experimental results obtained by measuring the urea degradation rate with the reaction time in the urea processing apparatus according to some embodiments.

FIG. 9 is a graph showing the experimental results obtained by measuring the urea degradation rate constant according to pH in the urea processing apparatus according to some embodiments.

FIG. 10 is a graph showing experimental results obtained by measuring the degradation rate of an oxidizer with the reaction time in the urea processing apparatus according to some embodiments.

### DETAILED DESCRIPTION OF EMBODIMENTS

In this disclosure, each of phrases such as “A or B”, “at least one of A and B”, “at least one of A or B”, “A, B or C”, “at least one of A, B and C”, and “at least one of A, B or C” may include any one of items listed together in the corresponding phrase among the phrases, or all possible combinations thereof.

Terms such as “first”, “second”, or “primary” or “secondary” may be used simply to distinguish that component from other components, and do not limit that component in other aspects (e.g., importance or order).

In some embodiments, the expression “hypobromite” means HOBr and/or OBr⁻ ions.

The urea processing apparatus according to some embodiments is provided for processing water, and may be suitable for producing ultra-high purity water. In the urea processing apparatus according to some embodiments, the water to be processed may pass through a plurality of processing steps. In those steps, inorganic and/or organic species present in the water to be processed may be separated. In particular, the urea processing apparatus according to some embodiments may be provided for processing water containing nitrogenous organic compounds such as urea as impurities.

Hereinafter, embodiments according to the technical idea of the present disclosure will be described referring to the accompanying drawings.

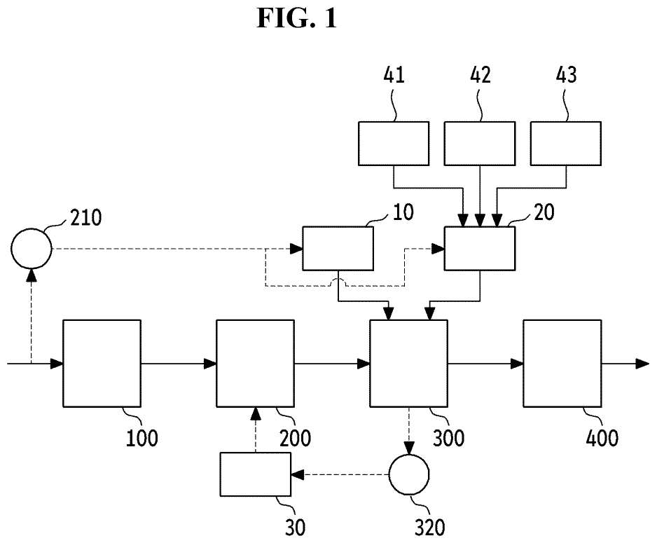

FIG. 1 is a diagram for explaining a urea processing apparatus according to some embodiments.

Referring to FIG. 1, the urea processing apparatus according to some embodiments may include a water collection tank 100, a pH adjustment tank 200, a reaction tank 300, and a processed water tank 400.

The water collection tank 100 may be configured to provide water to be processed that contains urea. The water collection tank 100 may be provided as a passage through which the water to be processed moves, or may be provided as a reservoir that stores the water to be processed. In FIG. 1, although the water collection tank 100 is shown to be connected to the pH adjustment tank 200 to provide the water to be processed to the pH adjustment tank 200, the technical idea of the present disclosure is not limited thereto. For example, the water collection tank 100 may be configured to be directly connected to the reaction tank 300 to provide the water to be processed to the reaction tank 300. In other embodiments of the present disclosure, the water collection tank 100 may not be present. The water collection tank 100 refers to an apparatus configured to store or move the water to be processed.

The pH adjustment tank 200 may be configured to control the hydrogen ion concentration (pH) of the water to be processed. For example, the pH adjustment tank 200 may control the hydrogen ion concentration (pH) of the water to be processed, using a pH adjuster. The pH adjustment tank 200 may be disposed between the water collection tank 100 and the reaction tank 300, and may be provided as a passage through which the water to be processed flows. The pH adjustment tank 200 may control the pH of the water to be processed to a level suitable for urea degradation, before the urea degradation reaction occurs in the reaction tank 300. This allows the pH adjustment tank 200 to stabilize the reaction pH. That is, by inputting the pH adjuster in advance, the pH adjustment tank 200 makes the reactants quickly reach the optimal pH, and may prevent pH fluctuations in the reaction tank 300.

In some embodiments, the pH adjustment tank 200 may control the pH of the water to be processed to have basicity, using the pH adjuster. The pH adjuster may be, but is not limited to, sodium hydroxide (NaOH), potassium hydroxide (KOH), calcium hydroxide (Ca(OH)₂), ammonium hydroxide (NH₄OH), sodium carbonate (Na₂CO₃), sodium bicarbonate (NaHCO₃), or the like.

In some embodiments, the urea processing apparatus may further include a pH analyzer 320. The pH analyzer 320 may be configured to measure pH of the reaction tank 300 to determine the amount of input of pH adjuster.

The pH analyzer 320 may be configured to measure pH in the reaction tank 300 to provide a pH measurement value. The pH measurement value may be transferred to a third tank 30. The third tank 30 may input an appropriate amount of pH adjuster to the pH adjustment tank 200 on the basis of the pH measurement value.

The pH measurement value may be transferred to the third tank 30 through an electrical signal. Although not shown, the urea processing apparatus according to some embodiments may further include a pH adjuster input amount control system.

In some embodiments, the pH adjustment may be further performed in the reaction tank 300. For example, the pH may increase due to an oxidizer that is input to the reaction tank 300. Therefore, in the pH adjustment tank 200, the pH adjustment may be performed by inputting a reduced amount of the pH adjuster on the basis of the pH value measured in the reaction tank 300.

The pH adjustment tank 200 may be configured to be connected to the third tank 30. The third tank 30 may be configured to store or discharge the pH adjuster.

However, in some embodiments, the pH adjustment tank 200 may not be present. For example, the pH adjuster may be immediately input to the reaction tank 300 to adjust the reaction pH. Although the pH adjustment tank 200 is shown to be provided to adjust the pH before the reaction in the reaction tank 300 in FIG. 1, the technical idea of the present disclosure is not limited thereto.

The reaction tank 300 may be configured to receive the water to be processed from the water collection tank 100 and react the water to be processed with an oxidizer and a catalyst. Here, the reaction may mean an oxidation-reduction reaction. For example, the reaction may be an oxidation-degradation reaction.

The catalyst may include at least one of nickel oxide (NiO), nickel peroxide (Ni₂O₃), cobalt ions (Co²⁺), or nickel hydroxide (Ni(OH)₂). In some embodiments, the catalyst may include nickel oxide (NiO). The mass of nickel oxide (NiO) may be 50 to 500 times that of urea.

When nickel oxide (NiO) is used as the catalyst, the concentration of nickel oxide (NiO) may be 0.01 g/L to 0.2 g/L. For example, when 10 to 200 μg/L of urea is present in the water to be processed, 0.01 g/L to 0.2 g/L of nickel oxide (NiO) may be required for efficient urea degradation. Specifically, the concentration of nickel oxide (NiO) may be 0.05 g/L to 0.1 g/L.

The catalyst may enable the efficient degradation of urea by increasing the reactivity of the oxidizer with urea. 90% or more of the urea in the water may be processed accordingly. That is, [Urea]/[Urea]₀ may be 0.1 or less. Here, [Urea]₀ means the molar concentration of urea in the water to be processed, and [Urea] means the molar concentration of urea after the reaction in the reaction tank.

In some embodiments, the oxidizer may include a halogen oxidizer. The oxidizer may include at least one of hypobromite (OBr⁻) or hypochlorite (ClO⁻) . In some embodiments, the molar concentration of hypobromite (OBr⁻) may be 5 to 80 times that of urea. Specifically, the molar concentration of hypobromite (OBr⁻) may be 5 to 20 times that of urea.

The removal of urea in the processed water may be performed by the following chemical reaction:

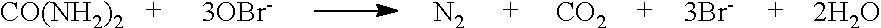

The above reaction may be performed at 10° C. to 40° C. If the reaction temperature is less than 10° C., the oxidation-degradation reaction rate of urea significantly decreases, which may make an efficient removal of urea difficult. On the other hand, if the reaction temperature is more than 40° C., the degradation of the oxidizer is promoted, which may cause problems such as increased consumption of the oxidizer, thereby increasing operating costs.

Specifically, the reaction temperature may be room temperature (20° C. to 25° C.). The above reaction temperature may be advantageous in terms of energy efficiency, since the reaction may be performed without separate heating or cooling.

The above reaction may be performed for 60 minutes or less. If a residence time of more than an hour is required to remove 90% or more of urea in the processed water, this may cause the reaction tank to occupy a considerable amount of area in an industrial-scale process. Therefore, a high-speed urea degradation reaction may be required to reduce site costs. By controlling the reaction time to 60 minutes or less, the site occupied by the urea processing apparatus may be minimized, and the economy of the process may be ensured.

In some embodiments, when a catalyst is added, the urea degradation rate may be improved by 1.2 to 6.5 times compared to a case where only the existing hypobromite (OBr⁻) oxidizer is used. That is, a catalyst may be used together to improve the urea degradation reaction rate. It may take 60 minutes or less to remove 90% or more of urea in the water to be processed.

The above reaction may be performed at a pH of 10 to 13. The reaction pH between urea, oxidizer, and catalyst may be 10 to 13. In order to improve the performance of the catalyst, the urea degradation reaction may proceed under a condition of pH 10 or more. Since the pH may increase by simply inputting an oxidizer to the reaction tank 300, the pH adjustment tank 200 inputs only a relatively small amount of pH adjuster, and the reaction tank 300 may finally control the reaction pH to 10 to 13.

The water to be processed may react with the oxidizer and catalyst in the reaction tank at 10° C. to 40° C. for 60 minutes or less. [Urea]/[Urea]₀ may be 0.2 or less, 0.1 or less, or 0.05 or less. Specifically, [Urea]/[Urea]₀ may be 0.1 or less. Here, [Urea]₀ means the molar concentration of urea in the water to be processed, and [Urea] means the molar concentration of urea after the reaction in the reaction tank.

The urea processing apparatus according to some embodiments of the present disclosure may further include a urea analyzer 210, a first tank 10, and a second tank 20.

The urea analyzer 210 may be configured to measure the concentration of urea in the water being processed and determine at least one of an amount of input of oxidizer or an amount of input of catalyst.

The urea analyzer 210 may be configured to measure the urea concentration in the water to be processed and provide a urea concentration measurement value. The urea concentration measurement value may be transferred to the first tank 10 and the second tank 20. Each of the catalyst and the oxidizer in an amount suitable for the urea degradation reaction may be input into the reaction tank 300 on the basis of the urea concentration measurement value.

The urea concentration measurement value may be transferred to the first tank 10 and/or the second tank 20 through an electrical signal. Although not shown, the urea processing apparatus according to some embodiments may further include a catalyst and/or oxidizer input amount control system.

The first tank 10 may be configured to store the catalyst or discharge the catalyst to the reaction tank on the basis of the amount of input of the catalyst. For example, the first tank 10 may be a catalyst reservoir. The first tank 10 may be connected to the reaction tank 300. That is, the first tank 10 may discharge the stored catalyst to the reaction tank 300.

The second tank 20 may be configured to synthesize the oxidizer, store the oxidizer, or discharge the oxidizer to the reaction tank on the basis of the amount of input of the oxidizer. For example, the second tank 20 may be an oxidizer synthesis tank. The second tank 20 may be connected to the reaction tank 300. The second tank 20 may discharge the stored and/or synthesized oxidizer to the reaction tank 300.

The second tank 20 may be configured to be connected to one or more raw material tanks 41, 42, and 43. The raw material tanks may be configured to store or discharge the oxidizer raw material that is input to the second tank 20.

The oxidizer raw material may be provided for manufacturing the oxidizer. For example, the raw material tanks may be made up of a sodium hypochlorite (NaOCl) reservoir 41, a sodium bromide (NaBr) reservoir 42, and a sodium hydroxide (NaOH) reservoir 43. The sodium hypochlorite reservoir 41 and the sodium bromide reservoir 42 may discharge the stored oxidizer raw material to the second tank 20. The second tank 20 may synthesize an oxidizer, using the input oxidizer raw material. The sodium hydroxide reservoir 43 may discharge the stored sodium hydroxide to the second tank 20 to adjust the pH of the oxidizer synthesized in the second tank 20.

In some embodiments, unlike the shown example, the raw material tank may be made up of two raw material tanks. For example, the raw material tank may be made up of a bromine (Br₂) reservoir and a sodium hydroxide (NaOH) reservoir. However, the embodiment is not limited thereto.

The first tank 10 and the second tank 20 may be disposed upstream of the reaction tank 300 and/or the pH adjustment tank 200. The raw material tanks may be disposed upstream of the second tank 20.

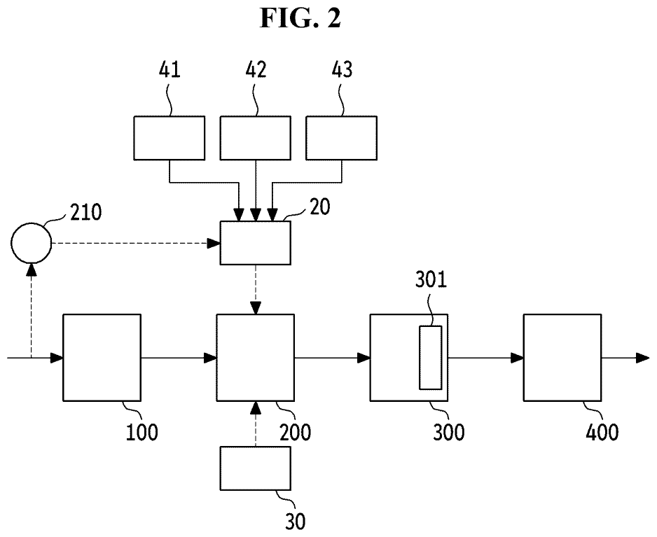

FIG. 2 is a diagram for explaining a urea processing apparatus according to some embodiments. For convenience of explanation, repeated parts of those explained above using FIG. 1 will be briefly explained or omitted.

Referring to FIG. 2, in the urea processing apparatus according to some embodiments, the reaction tank 300 may include a catalyst carrier 301 that carries catalyst.

The catalyst carrier 301 has a large specific surface area, which may increase the degree of dispersion of the catalyst. The catalyst carrier 301 has excellent mechanical strength and may be used for a long period of time. The catalyst carrier 301 may adjust the activity and selectivity of the catalyst depending on the type of carrier.

In the urea processing apparatus according to some embodiments, the nickel oxide (NiO) catalyst may maintain its catalytic activity even when it is used repeatedly. The catalyst may be carried on a structure by utilizing the activity retention properties of the catalyst and filled into the reaction tank 300.

The carrier may use, but is not limited to, alumina (Al₂O₃), silica (SiO₂), titania (TiO₂), zeolite, activated carbon, ceramic, metal oxide, or the like.

In some embodiments, the urea concentration in the water to be processed measured by the urea analyzer 210 may be transferred to the second tank 20. The second tank 20 may input hypobromite (OBr⁻) to the pH adjustment tank 200 in an amount of input suitable for urea removal. In the pH adjustment tank 200, the water to be processed may be mixed with hypobromite (OBr⁻). The water to be processed mixed with the hypobromite (OBr⁻) may pass through the reaction tank 300 including the catalyst carrier 301 which carries nickel oxide (NiO). The nickel oxide (NiO) catalyst is fixed to the carrier, and thus may be reused without flowing out.

The urea processing apparatus according to some embodiments may not include the first tank 10.

In the urea processing apparatus according to some embodiments, the second tank 20 may discharge the stored and/or synthetized oxidizer to the pH adjustment tank 200. When the reaction tank 300 includes the catalyst carrier 301, the water to be processed may be first mixed with the oxidizer and the pH adjuster in the pH adjustment tank 200.

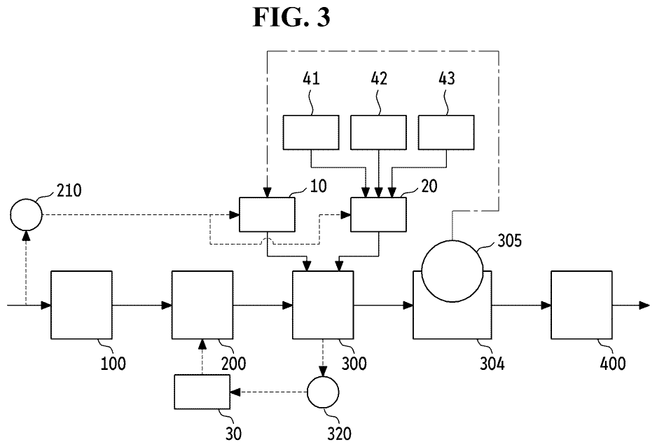

FIG. 3 is a diagram for explaining a urea processing apparatus according to some embodiments.

Referring to FIG. 3, the urea processing apparatus according to some embodiments may further include a catalyst recovery tank 304 and a drum magnet 305.

In some embodiments, the urea processing apparatus may further include the catalyst recovery tank 304. The catalyst recovery tank 304 may be configured to recover the catalyst when the catalyst has magnetic properties. The catalyst that is put into the reaction tank 300 and participated in the reaction moves to the catalyst recovery tank 304, is recovered by the drum magnet 305 disposed on the catalyst recovery tank 304, and may be transferred to the first tank 10 for reuse.

The processed water tank 400 may be configured to discharge the processed water subjected to the urea degradation reaction.

The urea processing apparatus according to some embodiments of the present disclosure includes the pH adjustment tank 200 configured to control the hydrogen ion concentration (pH) of the water to be processed, and the reaction tank 300 configured to be provided with the water to be processed from the pH adjustment tank 200 and to react the water to be processed with the oxidizer and the catalyst, and the reaction may be performed at a temperature of 10° C. to 00° C. for sixty minutes or less.

The urea processing apparatus according to some embodiments of the present disclosure includes the water collection tank 100 configured to provide the water to be processed that contains urea, and the reaction tank 300 configured to be provided with the water to be processed from the water collection tank and to react the water to be processed with the oxidizer and the catalyst. The oxidizer may include at least one of hypobromite (OBr⁻) or hypochlorite (ClO⁻), and the catalyst may include at least one of nickel oxide (NiO), nickel peroxide (Ni₂O₃) or nickel hydroxide (Ni(OH)₂).

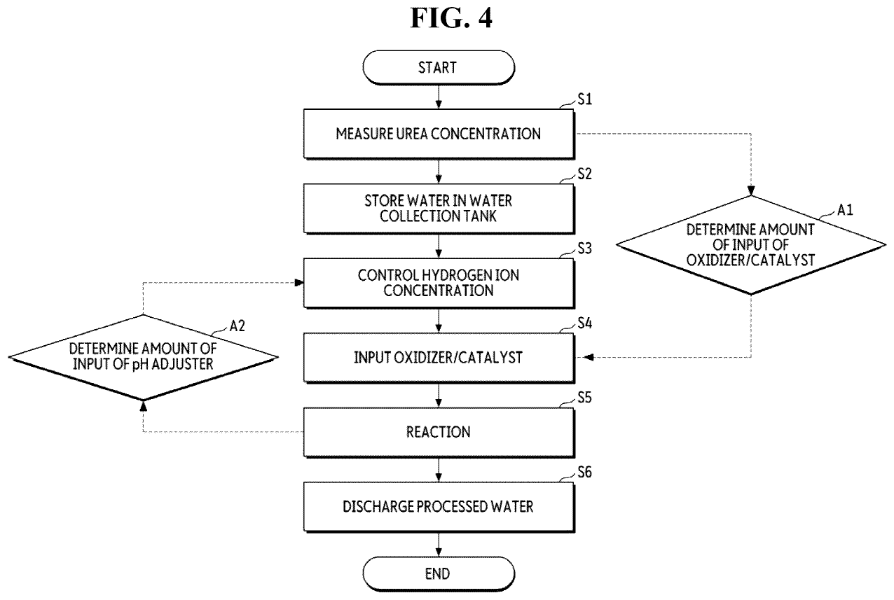

Hereinafter, the urea processing method according to some embodiments of the present disclosure will be described referring to FIG. 4.

FIG. 4 is a sequence flow diagram for explaining the urea processing method according to some embodiments. For convenience of explanation, repeated parts of those explained above using FIG. 1 will be briefly explained or omitted.

The urea processing method is a method for removing urea from the water to be processed, and may include a urea concentration measuring step S1 of the water to be processed that contains urea, a water collection tank storing step S2, a hydrogen ion concentration (pH) controlling step S3, an oxidizer/catalyst inputting step S4, a reaction step S5, and a processed water discharging step S6. The method may also include an oxidizer/catalyst amount of input determining step (A1) and a pH adjuster amount of input determining step (A2).

In the urea concentration measuring step S1, the urea concentration in the water to be processed may be measured, using the urea analyzer 210. The urea concentration measurement value may be transferred to the first tank 10 and the second tank 20 through an electrical signal. The urea analyzer 210 may determine (A1) the amounts of input of catalyst and oxidizer required for urea degradation. At this time, the amounts of input of catalyst and oxidizer may be automatically controlled on the basis of the measured urea concentration value.

In the water collection tank storing step S2, the water to be processed may be stored in the water collection tank 100. The water collection tank 100 may be provided as a passage for storing or moving the water to be processed. The water collection tank 100 may supply the water to be processed to the pH adjustment tank 200 and/or the reaction tank 300.

In the pH control step S3, the pH of the water to be processed may be adjusted to basicity, using the pH adjustment tank 200. The pH of the reaction tank 300 may be measured in real time through the pH analyzer 320. The third tank 30 may determine the appropriate amount A2 of input of the pH adjuster on the basis of the pH measurement value.

In the oxidizer/catalyst inputting step S4, the first tank 10 and the second tank 20 may input the catalyst and the oxidizer to the reaction tank 300, respectively.

The oxidizer to be input may include at least one of hypobromite (OBr⁻) or hypochlorite (ClO⁻) . The molar concentration of hypobromite (OBr⁻) may be 5 to 80 times that of the molar concentration of urea.

The catalyst to be input may include at least one of nickel oxide (NiO), nickel peroxide (Ni₂O₃), cobalt ion (Co²⁺) or nickel hydroxide (Ni(OH)₂). The concentration of nickel oxide (NiO) may be 0.01 to 0.2 g/L. The mass of nickel oxide (NiO) may be 50 to 500 times the mass of urea.

In the reaction step S5, the oxidizer, the catalyst and the water to be processed react in the reaction tank 300 to degrade the urea. The reaction may be performed for 60 minutes or less under temperature conditions of 10° C. to 40° C. 90% or more of the urea in the water to be processed may be removed through the above reaction.

The reaction may be performed at a pH of 10 to 13.

In the processed water discharging step S6, the processed water with the urea degraded may be discharged to the processed water tank 400.

The urea processing method according to some embodiments may measure the urea concentration in the water to be processed and determine the amount A1 of input of at least one of the oxidizer or catalyst on the basis of the measured urea concentration. At least one of the oxidizer or catalyst may be input into the reaction tank 300 according to the determined amount of input.

The method may further include controlling the hydrogen ion concentration (pH) of the water to be processed before the reaction.

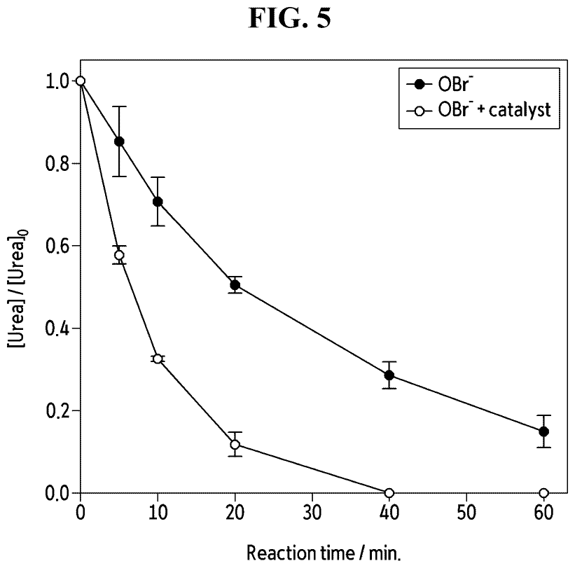

FIGS. 5 to 8 are graphs showing the experimental results obtained by measuring the urea degradation rate with the reaction time in the urea processing apparatus according to some embodiments.

FIG. 5 is a graph in which a case where only hypobromite (OBr⁻) is input to perform the urea degradation reaction is compared with a case where both hypobromite (OBr⁻) and the catalyst are input to perform the urea degradation reaction.

Referring to FIG. 5, when only hypobromite (OBr⁻) is input to perform the urea degradation reaction, it may be understood that it takes more than 60 minutes to degrade more than 90% of the urea present in the water to be processed.

On the other hand, when hypobromite (OBr⁻) and the catalyst are input together to perform the urea degradation reaction, it may be understood that it takes about 20 minutes to degrade more than 90% of the urea present in the water to be processed.

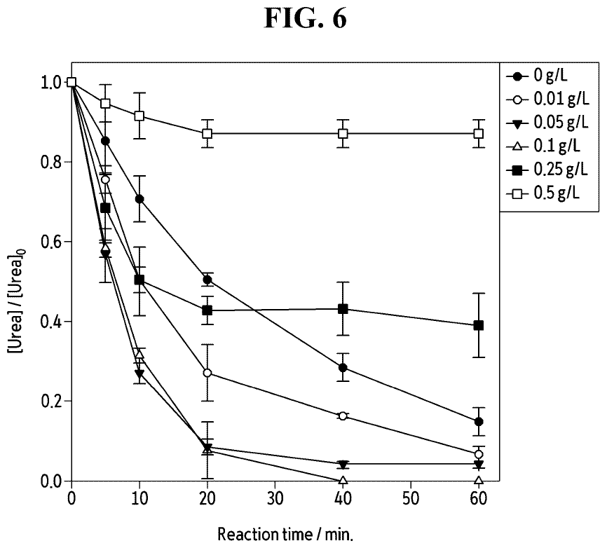

FIG. 6 is a graph showing the urea degradation rate depending on the reaction time with different concentrations of nickel oxide (NiO) catalyst. The above graph shows the test result in which the concentration of nickel oxide (NiO) is set to 0 g/L, 0.01 g/L, 0.05 g/L, 0.1 g/L, 0.25 g/L, and 0.5 g/L under the conditions of [Urea]₀=3.3 μM, [OBr⁻]₀=33 μM, and pH 11.0.

When nickel oxide (NiO) is contained at 0.01 g/L, it may be understood that 70% or more of urea is degraded by 20 minutes of reaction time, and 80% or more of urea is degraded by a reaction time of 40 minutes. In addition, when nickel oxide (NiO) is contained at 0.05 g/L or 0.1 g/L, it may be understood that 80% or more of urea is degraded by a reaction time of 20 minutes.

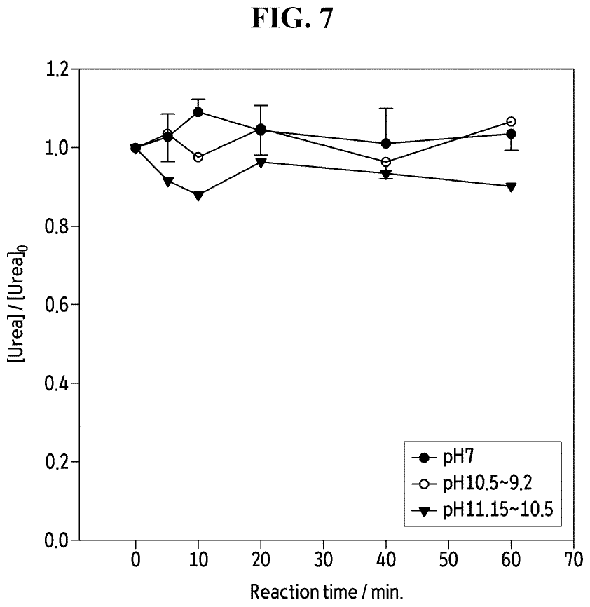

FIG. 7 is a graph obtained by measuring the urea removal rate when nickel oxide (NiO) is processed alone. Referring to FIG. 7, it may be understood that when [Urea]₀=3.3 μM and [NiO]₀=0.1 g/L are added, the urea removal does not occur regardless of reaction time and pH. In other words, it may be understood that nickel oxide (NiO) acts as a catalyst in the urea degradation process using hypobromite (OBr⁻).

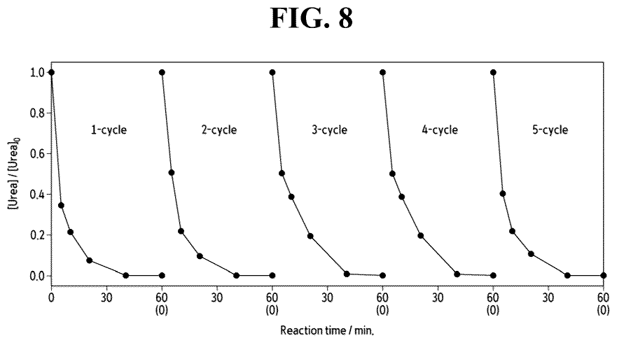

FIG. 8 is a graph showing the urea removal rate when nickel oxide (NiO) catalyst is used repeatedly. According to FIG. 8, it may be understood that the urea degradation effect is maintained while the catalyst is used a total of five times. It may be understood that the nickel oxide (NiO) catalyst maintains its catalytic activity despite the repeated use.

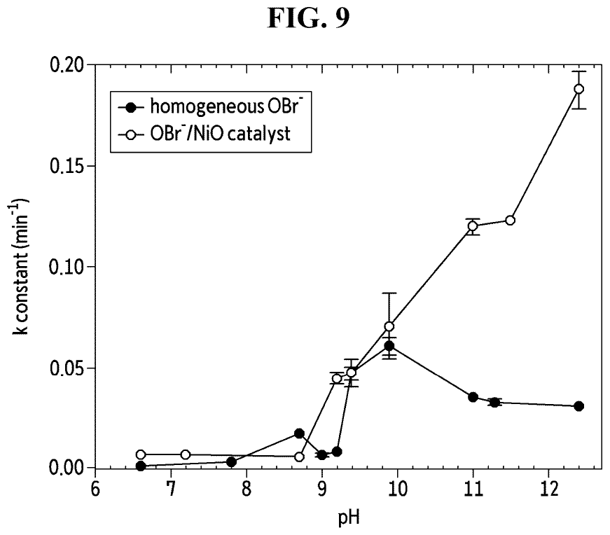

FIG. 9 is a graph showing the experimental results obtained by measuring the urea degradation rate constant according to pH in the urea processing apparatus according to some embodiments.

Referring to FIG. 9, it may be understood that the urea degradation reaction with nickel oxide (NiO) catalyst added under the conditions of [Urea]₀=3.3 μM, [OBr⁻]₀=33 μM, and [NiO]₀=0.1 g/L is accelerated from pH 10 or higher, and the difference in reaction rate increases as the reaction pH increases. This may mean that the primary reaction rate increases at pH 10 or higher. In other words, it may be understood that effective degradation of urea is possible under reaction conditions of pH 10 or higher.

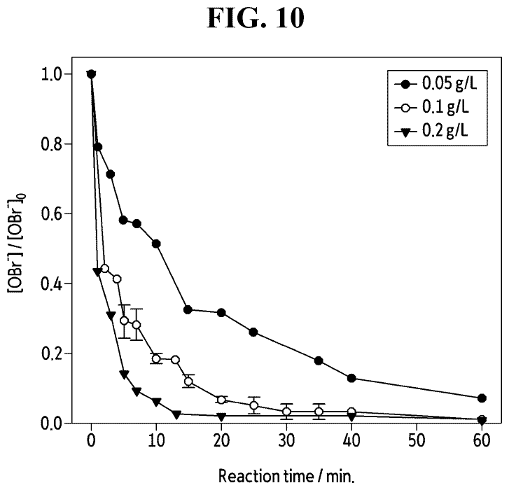

FIG. 10 is a graph showing experimental results obtained by measuring the degradation rate of an oxidizer with the reaction time in the urea processing apparatus according to some embodiments.

FIG. 10 is a graph showing the results of a urea degradation reaction performed under the conditions of [Urea]₀=3.3 μM, [OBr⁻]₀=33 μM, and pH 11.0 with the concentration of nickel oxide (NiO) set to 0.05 g/L, 0.1 g/L, and 0.2 g/L. It may be understood that the degradation of free bromine oxidizer (OBr⁻) was promoted when the catalyst was excessively input to 0.2 g/L.

Although the embodiments of the present disclosure have been described above with reference to the accompanying drawings, the present disclosure is not limited to the above embodiments, and may be fabricated in various different forms. Those skilled in the art will appreciate that the present disclosure may be embodied in other specific forms without changing the technical spirit or essential features of the present disclosure. Accordingly, the above-described embodiments should be understood in all respects as illustrative and not restrictive.

What is claimed is:

1. A urea processing apparatus comprising:
a water collection tank configured to provide water to be processed that contains urea; and
a reaction tank configured to receive the water to be processed from the water collection tank and react the water to be processed with an oxidizer and a catalyst,
wherein the reaction is performed at 10° C. to 40° C. for 60 minutes or less, and [Urea]/[Urea]₀ is 0.1 or less,
wherein [Urea]₀ means a molar concentration of urea in the water to be processed, and [Urea] means a molar concentration of urea after a reaction in the reaction tank.

2. The urea processing apparatus of claim 1, further comprising:
a urea analyzer configured to measure the urea concentration in the water to be processed and determine at least one of an amount of input of the oxidizer or an amount of input of the catalyst;
a first tank configured to store the catalyst or discharge the catalyst to the reaction tank based on the amount of input of the catalyst; and
a second tank configured to synthesize the oxidizer, store the oxidizer, or discharge the oxidizer to the reaction tank based on the amount of input of the oxidizer.

3. The urea processing apparatus of claim 2, further comprising:
one or more raw material tanks configured to store or discharge an oxidizer raw material that is input to the second tank.

4. The urea processing apparatus of claim 1, further comprising:
a pH adjustment tank configured to control a hydrogen ion concentration (pH) of the water to be processed; and
a third tank configured to store or discharge a pH adjuster that is input to the pH adjustment tank.

5. The urea processing apparatus of claim 4, further comprising:
a pH analyzer configured to measure pH of the reaction tank to determine the amount of input of the pH adjuster.

6. The urea processing apparatus of claim 1,
wherein the reaction tank comprises a catalyst carrier on which the catalyst is carried.

7. The urea processing apparatus of claim 1, further comprising:
a catalyst recovery tank configured to recover the catalyst by utilizing magnetic properties.

8. The urea processing apparatus of claim 1,
wherein the catalyst comprises at least one of nickel oxide (NiO), nickel peroxide (Ni₂O₃) or nickel hydroxide (Ni(OH)₂).

9. The urea processing apparatus of claim 8,
wherein the catalyst comprises nickel oxide (NiO),
a concentration of the nickel oxide (NiO) is 0.01 g/L to 0.2 g/L, and
a mass of the nickel oxide (NiO) is 50 to 500 times a mass of the urea.

10. The urea processing apparatus of claim 1,
wherein the oxidizer comprises at least one of hypobromite (OBr⁻) or hypochlorite (ClO⁻).

11. The urea processing apparatus of claim 10,
wherein the oxidizer comprises hypobromite (OBr⁻), and
a molar concentration of hypobromite (OBr⁻) is 5 to 80 times a molar concentration of urea.

12. The urea processing apparatus of claim 1,
wherein the reaction is performed at a pH of 10 to 13.

13. A urea processing apparatus comprising:
a pH adjustment tank configured to control a hydrogen ion concentration (pH) of water to be processed; and
a reaction tank configured to receive the water to be processed from the pH adjustment tank and react the water to be processed with an oxidizer and a catalyst,
wherein the reaction is performed at 10° C. to 40° C. for 60 minutes or less.

14. The urea processing apparatus of claim 13, further comprising:
a urea analyzer configured to measure a urea concentration in the water to be processed and determine at least one of an amount of input of the oxidizer or an amount of input of the catalyst;
a first tank configured to store the catalyst or discharge the catalyst to the reaction tank based on the amount of input of the catalyst; and
a second tank configured to synthesize the oxidizer, store the oxidizer, or discharge the oxidizer to the reaction tank based on the amount of input of the oxidizer.

15. The urea processing apparatus of claim 13,
wherein the catalyst comprises at least one of nickel oxide (NiO), nickel peroxide (Ni₂O₃) or nickel hydroxide (Ni(OH)₂).

16. The urea processing apparatus of claim 15,
wherein the catalyst comprises nickel oxide (NiO),
a concentration of the nickel oxide (NiO) is 0.01 g/L to 0.2 g/L, and
a mass of the nickel oxide (NiO) is 50 to 500 times a mass of the urea.

17. The urea processing apparatus of claim 13, further comprising:
a third tank configured to store or discharge a pH adjuster that is input to the pH adjustment tank.

18. The urea processing apparatus of claim 17, further comprising:
a pH analyzer configured to measure a pH of the reaction tank to determine the amount of input of the pH adjuster.

19. The urea processing apparatus of claim 13,
wherein [Urea]/[Urea]₀ is 0.1 or less,
wherein [Urea]₀ means a molar concentration of urea in the water to be processed, and [Urea] means a molar concentration of urea after reaction in the reaction tank.

20. A urea processing apparatus comprising:
a water collection tank configured to provide water to be processed containing urea; and
a reaction tank configured to receive the water to be processed from the water collection tank and react the water to be processed with an oxidizer and a catalyst,
wherein the oxidizer comprises at least one of hypobromite (OBr⁻) or hypochlorite (ClO⁻), and
the catalyst comprises at least one of nickel oxide (NiO), nickel peroxide (Ni₂O₃) or nickel hydroxide (Ni(OH)₂).
